(19) United States
(12) Patent Application Publication
(10) Pub. No.: US 2008/0013496 A1
(43) Pub. Date: Jan. 17, 2008

(54) Wireless Communication System, Wireless Communication Device for Use as a Station in a Wireless Communication System, a Method of Communication Within a Wireless Communication System

(75) Inventors: Francesc Dalmases, Bellaterra - Barcelona (ES); Jorg Habetha, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,981

(22) PCT Filed: Jun. 8, 2005
(86) PCT No.: PCT/IB05/51867

§ 371 Date: Dec. 4, 2006

(30) Foreign Application Priority Data
Jun. 9, 2004 (EP) 04102635.2

(51) Int. Cl. H04J 3/00

(52) U.S. Cl. 370/336

(57) ABSTRACT

The invention relates to a wireless communication system comprising a master station, a first additional station, and a second additional station, whereby the master station is operable to communicate with the first and second additional stations in a first high-speed mode utilizing a first channel and at least a second channel and in a second low-speed mode utilizing either the first channel or the second channel, the first additional station is operable to communicate in the first mode utilizing the first channel and at least the second channel, and the second additional station is arranged to communicate in the second mode utilizing either the first channel or the second channel, characterized in that master station is arranged to define a plurality of first time slots on the first channel and a plurality of second timeslots on the second channel for communication in the first mode, and a plurality of third time slots on the first channel and a plurality of fourth time slots on the second channel for communication in the second mode.

The invention relates to a wireless communication system as defined in the preamble of claim 1.

The invention also relates to a station for use in a wireless communication system and a method of communication within a wireless communication system.

Such a wireless communication system is disclosed in IEEE Std. 802.11a, 1999, Wireless LAN Medium Access Control (MAC) and Physical (PHY) specifications: High Speed Physical Layer in the 5 GHz Band, IEEE, NY, 1999. A wireless communication system conforming this standard operates in the 5 GHz license free ISM band is able to support raw date rates ranging from 6 to 54 Mbit/sec using orthogonal frequency division multiplexing (OFDM). IEEE Std 802.11b discloses a similar communication system for operation in the 2.4 GHz ISM band. To satisfy the requirements of delay-bounded applications, a new specification has been proposed p802.11e incorporating data link layer functions to offer both statistic and parameterized QoS.

To support data rates up to about 100 Mbit/sec in the data link layer a new specification p802.11n will be proposed. In this proposal extensions to the 11a-based PHY and the 11e-based MAC standards are introduced, while keeping a certain level of backward compatibility. The PHY extensions are based on the support of multiple antenna systems (MIMO) and transmission in 40 MHz bands, so-called dual channel operation.

Wireless local area networks (WLANs) such as wireless communication systems compliant with one of the versions of IEEE Std. 802.11 or its proposed extensions are organized in cells or so-called basic service sets. Such cells comprise a number of wireless stations. One station within such a cell is arranged to provide communication with other cells, a master station or access point via an inter-cell system or distribution system.

In such a wireless communication facilitating a first mode for high-speed or high-throughput communication, while maintaining compatibility for communication devices or stations capable of communicating in a second low-speed mode the master station has to be arranged to facilitate communication in both the first high-speed and the second low-speed mode.

In such a wireless communication system sub-bands or communication channels are used to establish communication links. In for instance IEEE Std. 802.11a and 11g 20 MHz wide communication channels are used within the 5 GHz and 2.5 ISM bands respectively. In IEEE P802.11n it is proposed that a basic service set can operate in a single-channel mode (20 MHz bandwidth) or dual-channel mode (40 MHz bandwidth). In the dual-channel mode a first channel is defined as so-called control channel and a second channel as so-called extension channel. The presence of legacy devices (e.g. 802.11a stations) in the control channel is allowed. However if the presence of legacy devices is detected in the extension channel, the master station has to select other communication channels.

A disadvantage of communicating in this way is that it is rather inflexible and may lead to an under utilization of the available communication channels.

Amongst others it is an object of the invention to provide a wireless communication system having a higher degree of flexibility in communication between stations with the wireless communication system.

To this end the invention provides a wireless communication system as defined in the opening paragraph of claim 1 which is characterized by the characterizing portion of claim 1.

By creating separate time slots for low-speed mode communication and high-speed mode communication in both the control channel and in the extension channel the number of channels that can be used for communication in the high-speed mode is increased. Thereby the flexibility of the wireless communication system is increased.

The master station is arranged to facilitate communication in a first high speed and the second low speed mode by creating time slots allowing transmission in the first mode and other time slots allowing communication in the second mode. In IEEE P802.11n this is achieved by having the master station transmitting an allocation signal that allocates time frames or slots for high-speed communication and others for low-speed communication. For this purpose a so-called network allocation vector (NAV) can be used e.g. a Clear-To-Send (CTS) frame or a beacon that contains a contention-free period.

The above and other objects and features of the present invention will become more apparent from the following detailed description considered in connection with the accompanying drawings in which:

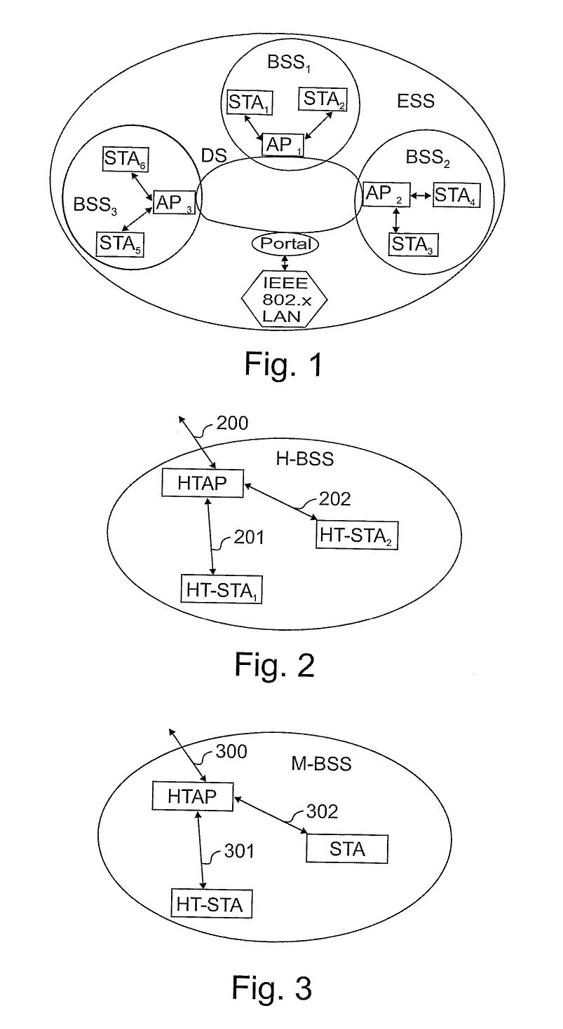

FIG. 1 shows a general overview of a communication system according to one of the group of IEEE Std. 802.11 specifications;

FIG. 2 shows an overview of a high throughput basic service set of a communication system;

FIG. 3 shows an overview of mixed basic service set of a communication system according to the invention.

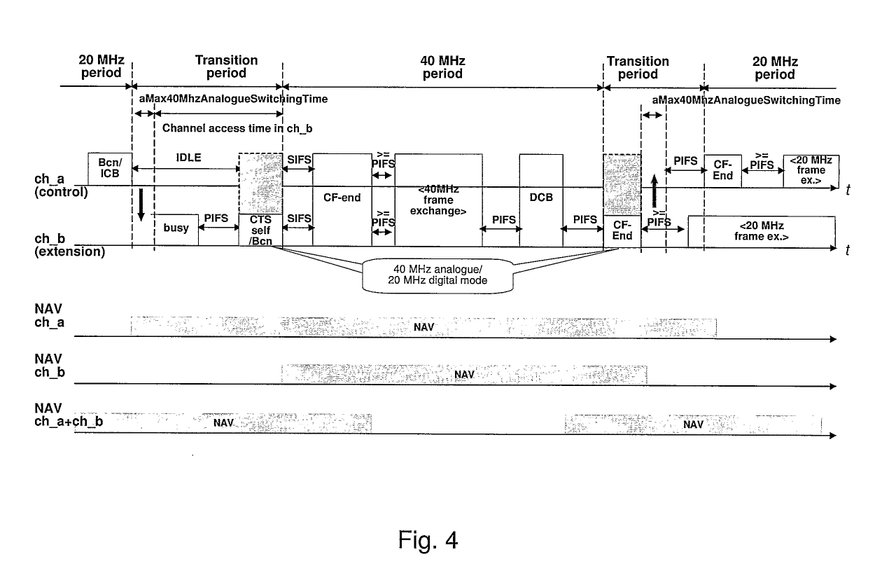

FIG. 4 shows a signaling diagram for a 20 MHz base management Mixed mode.

In these figures identical parts are identified with identical references.

FIG. 1 shows a general overview of a communication system according to one of the group of IEEE Std. 802.11 specifications. The basic element in the network architecture is called the basic service set (BSS). The BSSₙ is defined as a group of stations (wireless nodes) which are located within a general limited physical area within which each station (STA) is theoretically capable of communicating with every other STA (assuming an ideal environment with no communication barriers, physical or otherwise). There are two basic wireless network design structures defined, ad hoc and infrastructure networks.

An infrastructure-based IEEE 802.11 wireless network or communication system is composed of one or more BSSs which are interconnected through another network such as an IEEE 802.3 wired Ethernet network. This connecting infrastructure is called the Distribution System (DS). With this infrastructure each BSSₙ must have exactly one wireless station connected to the DS. This station provides the functionality to relay messages from the other STAs of the BSSₙ to the DS. This STA is called the Access Point (AP) for its associated BSSₙ. The entity comprised of the DS and its connected BSSs is called an Extended Service Set (ESS). For the purposes of IEEE 802.11, the fact that the DS can move data between BSSs and to/form an external Portal is assumed, however the method used by the DS to accomplish this function is not defined.

An ad hoc wireless network is basically the opposite of an infrastructure-based wireless LAN (WLAN). An ad hoc WLAN has no infrastructure, and therefore no ability to communicate with external networks. An ad hoc WLAN is normally setup purely to permit multiple wireless stations to communicate with each other while requiring as little external hardware or management support as possible. The BSS of an ad hoc network is referred to as an Independent BSS (IBSS), which is not illustrated

A wireless communication system extending the existing IEEE 802.11 specifications, for instance a wireless communication system according to proposal P802.11n, while maintaining backward compatibility needs to support different modes of communication. To provide compatibility with legacy (IEEE 802.11a/g) devices, in infrastructure mode a basic service set controlled by a P801.11n compliant high-throughput access point (HTAP) has three operating modes:

Pure mode: where legacy STAs cannot associate to the BSS; In this pure mode no legacy stations are present.

Managed-mixed mode: where legacy STAs can associate and the coexistence between high throughput (HT-STAs) and legacy STAs is managed by the HTAP through time division; There are two sub modes within the mixed managed mode. The first one is the mixed capable mode. In this mode there are no legacy stations, but the HTAP is able to accept the association from legacy stations that discover the HTAP or try to register at this HTAP, by receiving a legacy beacon from the HTAP. That means the beacon is sent out in an operation mode, which could be recognized by the legacy stations. The second mode is the managed mixed mode. In this mode the time is divided between contention free periods for HTSTA and legacy stations by selectively selecting the NAV (network allocation vector). The HTAP is transmitting headers which could be recognized by the legacy stations, wherein the header contains the time period of the data packet and/or the end of the data packet, thereby reserving a time in which the medium is blocked. Further the time for transmitting an acknowledgement signal is included in the header. Station receiving such header will set its NAV to the time of the end of the packet. So they will not access the medium during the signaled time. A part of the managed mixed mode may be the 20 MHz-Base managed mixed mode. In this mode the BSS contains both legacy and HT stations. There may be legacy stations of overlapping BSS in either or both of the channels. Legacy and HT stations associate to the AP's BSS in the control channel. The AP manages the generation of 40 MHz or HT periods and 20 MHz or low speed periods. During the 40 MHz period HT stations are allowed to access the medium in 40 MHz. The legacy stations are not allowed to access the medium at this time. During the 20 MHz period legacy stations are allowed to access the medium in 20 MHz.

Unmanaged mixed mode: where legacy STAs can associate and the coexistence is not managed by the HTAP.

The high-throughput stations HT-STAs may also operate in three different modes:

Pure mode: the STA communication does not require protection of high-throughput frames;

Mixed mode: this mode provides a protection mechanism of legacy communication (spoofing, etc.);

Legacy mode: in this mode the STA communicates as if it where a legacy station.

In a managed-mixed BSS and a pure BSS the high-throughput HT-STA uses the Pure mode. In an unmanaged BSS the high-throughput STA uses the mixed mode. The Legacy mode is used if no HTAP is detected.

In managed-mixed mode the HTAP divides the time between high-speed or high-throughput communication and low-speed or legacy communication. This division in separate time-slots for high-speed communication and low-speed communication is accomplished by using a so-called network allocation vector NAV, for instance by sending a Clear-To-Send (CTS) frame or a beacon frame that contains a contention-free period and by which legacy stations and/or high-throughput stations are informed that they may not transmit during a time defined by the contention-free period.

In a basic service set of wireless communication system sub-bands or communication channels are used to establish communication links. In for instance IEEE Std. 802.11a and 11g 20 MHz wide communication channels are used within the 5 GHz and 2.5 ISM bands respectively. In IEEE P802.11n it is proposed that a basic service set can operate in a single-channel mode (20 MHz bandwidth) or dual-channel mode (40 MHz bandwidth). In the dual-channel mode a first channel is defined as so-called control channel and a second channel as so-called extension channel. The presence of legacy devices (e.g. 802.11a stations) in the control channel is allowed. However if the presence of legacy devices is detected in the extension channel, the master station has to select other communication channels.

FIG. 2 shows an overview of a high throughput basic service set (H-BSS) of a communication system extending the existing IEEE 802.11 specifications. The shown H-BSS comprises three STAa, a High-Throughput Access Point (HTAP), and two other High-Throughput stations, HTSTA1 and HTSTA2. The shown H-BSS may be for instance a wireless communication system according to proposal P802.11n operating in infrastructure mode. Within the high throughput basic service set H-BSS the first high throughput station HTSTA1 communicates with high throughput access point HTAP via a first high throughput communication link 201. The second high throughput station HTSTA2 communicates with high throughput access point HTAP via a second high throughput communication link 202. High throughput access point HTAP is connected to a distribution system via communication link 200.

FIG. 3 shows an overview of mixed basic service set (M-BSS) of a communication system according to the invention. The shown M-BSS comprises a High-Throughput Access Point (HTAP), a High-Throughput station (HT-STA), and a station (STA) compliant with a legacy communication standard. Therefore it can only communicate in a low-speed mode, while both the HTAP and the HT-STA can communicate both in a high-speed mode and the low-speed mode. HTAP and HT-STA communicate with each other on communication link 301. HTAP and STA communicate with each other in a low-speed mode on communication link 302. HTAP will communicate via communication link 300 and the distribution system to other basic service sets.

In the known wireless communication system shown in FIG. 1 the M-BSS may operate both in a single-channel mode and an dual-channel mode. As explained in connection with the system shown in FIG. 1 a known way facilitate both high-speed mode communication and low-speed mode communication when operating in dual channel mode is allocate a first channel or control channel to communication of control and broadcast messages, and low-speed mode communication compliant with the legacy communication standard. In the known wireless communication system a second channel or extension channel is reserved for high-speed mode communication only. In case low-speed legacy communication is detected in the extension channel, the HTAP in the known wireless communication has to select new communication channels.

The system according to the invention allows low-speed mode legacy communication in both the control channel and the extension channel. The system according to the invention operates in the following way.

Before determining the mode of operation of the basic service set (pure mode, managed mixed-mode, or unmanaged mixed-mode) the HTAP will scan channels for the presence of legacy stations (STAs). The HTAP will try to select a pair of channels in which fewest number of STAs operate. If the HTAP detects two adjacent channels without any STAs, the HTAP will establish operation in the pure mode or mixed capable mode. If the HTAP does not detect two adjacent channels that are clear of STAs, it will try to select channel pairs (of two adjacent channels) in which STAs are present in only one channel. In this case the HTAP will establish operation in the managed-mixed mode or the unmanaged mixed-mode. If the HTAP only detects pairs of channels in which legacy stations are present in both channels, it will establish operation in the managed mixed-mode.

Once the HTAP has selected two channels (a control channel and an extension channel) for communication and established operation of the basic service set in the pure mode, mixed-capable mode or unmanaged mixed-mode it may happen that one or more legacy stations start operating in either the control channel or the extension channel. If the HTAP operates in one of these modes and detects the presence of a low-speed legacy station in the extension channel, it switches to managed mixed-mode. Alternatively, if the traffic or communication generated by the legacy stations increases the HTAP may decide to switch to single-channel mode.

As discussed above in managed mixed-mode the HTAP defines time slots in which legacy low-speed stations may communicate and other time slots in which high-speed stations may communicate. A way to protect transmission of HTSTAs in dual-channel mode is to have the HTAP transmit legacy Request-To-Send (RTS) or Clear-To-Send (CTS) frames simultaneously in both channels or with a certain offset. This method is described in European Patent application 03104273.

In an alternative method used in the wireless communication system according to the invention the HTAP sends simultaneously or with a certain predetermined offset with respect to each other two legacy beacons in the control channel and in the extension channel respectively. The legacy beacons define contention free periods in both channels which can be used for high-speed mode communication by the HTAP and the HT-STAs.

Referring to FIG. 4 the invention will be explained in more detail. The HTAP controls the operating mode of its STA through an information element included in the beacon. In pure mode, the HTAP will ignore any probe requests sent by legacy STAs and any legacy beacons sent by overlapping co-channel legacy devices. The HTAP transmits its beacon using a HT-physical channel protocol data unit (PPDU) type, which could not be recognized by legacy stations. The beacon contains an HT management element that requires pure mode operation of its STAs. Note, use of pure mode at the HTAP is only suitable for managed installations where it is not permitted that legacy APs may share the same channels as HTAPs.

In the mixed-capable mode, the HTAP transmits its beacon using a legacy PPDU. The beacons contain an HT management element that indicates this is an HTAP. This will stop other co-channel mixed-capable APs from considering the AP to be a legacy AP.

In a mixed-capable BSS, an HT STA is operating in pure mode except when communicating with a legacy STA using DLP (direct link protocol, also called direct link setup DLS).

In the mixed-capable mode, the AP may receive association and probe requests from legacy STAs. It will respond to a legacy probe request with a legacy probe response. The AP will respond to a legacy association request with a legacy association response. The AP may choose to accept or deny the association request. If the AP sends an association response with status=OK, it will enter either managed, unmanaged or 20 MHz-base managed mixed mode operation, and stay there while it has any associated legacy STA. The AP monitors its channel for a legacy co-channel BSS, and if it detects one, transitions into mixed mode, or attempts to find an alternative channel.

In the unmanaged mixed mode, the AP transmits its beacon using the legacy PPDU type. The beacon contains an HT management element that requires mixed mode operation of its STAs. STAs in an unmanaged mixed mode BSS may use legacy or HT transmissions.

In the 20 MHz-base managed mixed mode, the AP transmits its beacon using the legacy PPDU type. The beacon is transmitted on the control channel but for the purpose of reserving the extension channel, an AP may send beacons also in the extension channel. Beacons in the extension channel may cause legacy STAs to attempt association but the HT AP will deny association or may ignore those requests. The beacon contains an HT management element that requires mixed mode operation of its STAs.

As mentioned above a HT STA supports three possible modes of operation in an infrastructure system as shown in FIG. 2: legacy, mixed and pure mode.

In pure mode, there are no overlapping legacy STAs. Protection of HT frames from legacy devices is not required.

In mixed mode, the HT STA is operating in the presence of legacy STAs co-channel on the control channel and/or the extension channel. These STAs may be part of the same BSS, or may be associated with an overlapping legacy BSS. In mixed mode, use of a legacy protection mechanism is required, e.g. MAC layer protection, long NAV, truncation of TXOP or spoofing. During spoofing a spoofed NAV duration is virtually set in the PHY header by using the length and rate field of a legacy SIGNAL field. The rate field declares the rate that the packet is coded in after the PHY header, and the length field declares the length of the packet (after the PHY header) in bytes. When a legacy node receives this SIGNAL field, it starts to decode the rest of the packet in the specified rate and will continue to do so until the end of length/rate time. The spoofed NAV uses this characteristic of the length and rate fields, so that the length/rate is equivalent to the intended NAV Duration. A legacy node that is spoofed by these two fields is prevented to start transmission during that period. This way transmission protection can be achieved without requiring that legacy nodes can receive the Mac-PDU contents.

A 40 MHz capable HT STA, whose permitted width set is 20 and 40 MHz, will switch to 20 MHz mode for communication with a 20 MHz HTSTA.

In 20 MHz-base managed mixed mode, a 40 MHz capable HT STA is enabled to communicate in 40 MHz mode during the 40 MHz period. In case a 40 MHz capable HT STA wishes to communicate with a 20 MHz mode HT STA or with a legacy STA, it will communicate with the 20 MHz mode HT STA in the 20 MHz period.

In legacy mode, the HT STA operates exactly as a legacy device, with the exception that it may switch from legacy mode to mixed or pure modes while scanning in order to detect an HTAP.

Now the coexistence mechanism is described where a BSS operates in 20 MHz mode and switches to a 40 MHz capable phase under the control of an HTAP. Both legacy and HTSTAs may be associated in the BSS. An HT STA may be either a 40 MHz capable HTSTA or a 20 MHz HTSTA. Legacy STAs associate with the HTAP on the control channel.

According to the invention in the 20 MHz-base managed mixed mode an overlapping of BSS containing legacy STAs in both control and extension channels is allowed. Due to the protection of the 40 MHz period in both channels, it is tolerant of overlapping BSSs. The HTAP, before it selects a control channel and extension channel and operating mode may take into account the likely performance benefits of using the 20 MHz base mode operation. The HTAP tries to avoid overlapping 802.11e or 802.11b STA, particularly on the extension channel. As mentioned above in the 20 MHz-base managed mixed mode legacy STAs and HTSTAs may coexist. Two types of STAs may coexist with the 40 MHz capable HTSTAs in the 20 MHz-base managed mixed mode: legacy STAs and 20 MHz HTSTAs. Legacy STAs cannot receive HT PPDUs and cannot interpret MAC duration values. The 20 MHz HTSTAs are not able to receive 40 MHz mode HT PPDUs and to interpret their MAC duration values. An HTAP in the 20 MHz-base managed mode provides legacy protection against legacy STAs and 20 MHz HTSTAs.

Now reference is made to FIG. 4. The 40 MHz capable HTAP operates in the 20 MHz-base managed mixed mode. It divides time into 20 MHz and 40 MHz periods as illustrated in FIG. 4. In a 20 MHz period, it ensures that the NAV of 40 MHz mode operation in 40 MHz capable HTSTAs is set. In the 40 MHz period, the NAV of legacy STAs and 20 MHz HTSTAs is set.

The basic period is the one in which operation is strictly in the 20 MHz control channel. To start a 40 MHz period, the HTAP first reserves the control channel by setting NAV of legacy and 20 MHz HTSTAs with a legacy Beacon frame BCN or an ICB frame. The transmission rate of the SCB frame is selected from the BSSBasicRateSet. Due to the range of the Duration/ID field in the MAC header, the ICB frame cannot be used to start a 40 MHz period longer than 32767 μs. Then, the HTAP shifts to the extension channel (ch_b) for its reservation. The extension channel ch_b is reserved by a transmission of a CTS-to-self or a legacy Beacon Bcn frame after an appropriate channel access is performed in the extension channel ch_b.

The Beacon frame Bcn sent to reserve the control channel ch_a includes the channel extension indication information element. When a 40 MHz capable HTSTA associated with the HTAP receives the Beacon frame Bcn, it extends its channel bandwidth to 40 MHz according to the information in the Extension Channel Offset information element. The 40 MHz capable HTSTAs act in the same way when receiving an ICB (increase channel bandwidth) control frame.

After setting the NAV in the extension channel ch-b is completed, the HTAP resets the NAV of 40 MHz capable HTSTAs by sending a CF-end frame. Thereby the 40 MHz period is started, during which HTSTAs can communicate in 40 MHz mode.

To end the 40 MHz period, the HTAP first sets the NAV of 40 MHz mode operation in 40 MHz capable HTSTAs by transmitting an DCB (decrease channel bandwidth) frame. The 40 MHz capable HTSTAs will switch back to the control channel ch_a in 20 MHz. Then the HTAP resets the NAV in the extension channel ch_b by transmitting a CF-End frame. The AP may reset the NAV in the control channel ch_a by a CF-End frame but it may also continue the CFP (contention free period) that was set in the last Beacon frame Bcn on the control channel ch_a. At this point the HTAP and all its STAs are operating on the control channel using 20 MHz channel width. The process may e.g. be repeated periodically, such as related to the beacon interval. The superframe thus created is divided into a phase for communication on the 40 MHz channel and phases for communication on the 20 MHz channels. One cycle of the process is illustrated in FIG. 4.

A 40 MHz capable HTSTA that is attempting an channel access during a 40 MHz period either freezes the backoff counter during 20 MHz operation and resumes the interrupted backoff during the next 40 MHz period or selects a new random backoff at the start of the 40 MHz period. Likewise, if it is attempting a channel access during a 20 MHz period, it either freezes the backoff counter during 40 MHz operation and resumes the interrupted backoff during the next 20 MHz period or it selects a new random backoff at the start of the 20 MHz period.

To start the 40 MHz period, the HTAP transmits a legacy Beacon frame Bcn or an ICB frame in the control channel ch_a to acquire the control channel ch_a and define a control access phase to block the channel by setting the NAV of the legacy STAs and 20 MHz HTSTAs on the control channel ch_a. The contention free period CFP of the Beacon or Duration field of the ICB frame will be set to cover the 40 MHz phase plus the transition periods between 20 and 40 MHz operation.

The HTAP announces the “extension channel access timeout” value in its Beacon and Probe Response frames to limit the maximum transition time to the 40 MHz period. When the HTAP transmits the Beacon frame Bcn or ICB frame on the control channel ch_a, it starts a timer of a duration, which is “Extension Channel Access Timeout” minus the duration of the Beacon or ICB frame. The “Extension Channel Access Timeout” is the maximum time, after which the STAs will have received the Beacon or CTS-to-self on the extension channel ch_b. One reason why the HTAP might not be able to send the Beacon or CTS-to-self frame within “Extension Channel Access Timeout” time could be a busy medium on the extension channel ch_b.

After setting the NAV in the control channel ch_a, the HTAP may switch to 40 MHz analogue and 20 MHz digital mode and will listen to both the control channel ch_a and the extension channel ch_b. As the control channel ch_a is supposed to be reserved by the previous operation, this phase is mainly given to wait for the extension channel ch_b to be idle. However, it will be noted that while waiting for the extension channel ch_b to become idle, the control channel ch_a will be left without any activity and the STAs which did not receive the Beacon Bcn or ICB frame in the control channel ch_a may interfere with the reservation. The purpose of the mode transition to 40 MHz analogue and 20 MHz digital is to omit an analogue channel switch at the beginning of the transmission phase in the 40 MHz channel. If the extension channel ch_b becomes idle the AP will transmit a CTS-to-self or legacy Beacon Bcn in the extension channel ch_b after a time period (PIFS) it has become idle. The CTS-to-self or Beacon Bcn will block the extension channel ch_b by setting the NAV of the legacy STAs on the extension channel ch-b. The NAV is covering the intended duration of the 40 MHz period and the transition times between 20 MHz period and 40 MHz period as illustrated in the lower part of FIG. 4.

If the “extension channel access timeout” timer at the HTAP expires while attempting to transmit CTS-to-self or Beacon Bcn, the HTAP will give up switching to the 40 MHz bandwidth and may try again at a later time. The HTAP will furthermore transmit a CF-end frame on the 20 MHz control channel in order to re-set the NAV of the legacy STAs on the control channel ch_a. HTSTAs will have started an “Extension Channel Access Timeout” timer themselves after having received the first Beacon or ICB frame on the control channel ch_a and do therefore not have to be notified by the HTAP about the expiration of the timer.

The NAV setting in the extension channel ch_b is done through CTS-to-self or Beacon Bcn. CTS-to-self would give less overhead, however, the Beacon Bcn in the extension channel ch_b may avoid other BSSs being created, since other STAs will detect the presence of the H-BSS. Furthermore, the duration of the NAV that can be signaled by a CTS-to-self is limited. Therefore, for long periods setting the NAV by a Beacon frame Bcn will be required. According to this analysis, one may decide to send Beacons in the extension channel ch_b.

If the “Extension Channel Access Timeout” timer has not yet expired, the HTAP will transmit a 40 MHz mode CF-end to signal to the HTSTAs that the 40 MHz channel is available. The CF-end frame is transmitted at least “aMax40MhzAnalogueSwitchingTime” after the end of the first Beacon or ICB frame on the control channel ch_a. The “aMax40 MhzAnalogueSwitchingTime” is the maximum allowed time for the STAs and the HTAP to carry out an analogue channel switch from 40 MHz to 20 MHz and vice versa. The HTAP has to wait at least “aMax40MhzAnalogueSwitchingTime” before starting the 40 MHz phase in order to account for the STA with the slowest possible switching time. If “aMax40MhzAnalogueSwitchingTime” time has already expired since the end of the Beacon Bcn or ICB frame on the control channel ch_a, the HTAP will send the CF-end frame a SIFS-time after the CTS-to-self or Beacon Bcn on the extension channel ch_b.

After the 40 MHz frame exchanges, the HTAP is setting the NAV of the 40 MHz HTSTAs until the intended end of the 20 MHz period by means of a DCB-frame (decrease of bandwidth). Then the HTAP will free the extension channel ch_b and the control channel ch_a for communication in 20 MHz mode by transmitting CF-End frames in both channels. The CF-End frame in the control channel ch_a is not required if the HTAP wishes to continue the contention free period. The CF-End frame on the control channel ch_a is not sent earlier than “aMax40MhzAnalogueSwitchingTime” after the CF-End on the extension channel ch_b. The first CF-End frame in the extension channel ch_b may be transmitted in 40 MHz analogue and 20 MHz digital mode in order to avoid an additional analogue channel switch. After the first CF-End frame the HTAP switches to the control channel ch_a in 20 MHz analogue mode and transmits the second CF-End frame.

The ratio between the 40 MHz and 20 MHz period should be adjusted according to types of traffic and priority. Whether frames are sent in the 40 MHz or 20 MHz period is scheduled depending on their traffic types.

It is noted that in scenarios with heavy interference between control channel ch_a and extension channel ch_b the HTAP may choose to switch to a different 40 MHz channel, on which no time-sharing with legacy STAs might be required. The selection of channels affects the performance and efficiency for the 20 MHz-base managed mixed mode. Not only the initial channel selection but also monitoring the channels while operating in 20 MHz-base mixed mode is necessary to cope with condition changes.

A 40 MHz capable HTSTA is allowed to operate in 20 MHz mode on the control channel ch_a or in 40 MHz mode on both channels ch_a and ch_b. It is not allowed to operate in 20 MHz mode on the extension channel ch_b.

40 MHz capable HTSTAs will store the “extension channel access timeout” value contained in Beacon Bcn or Probe Response frames sent by an HTAP.

When a HTSTA receives a Beacon Bcn or ICB frame with channel extension indication information element set, it will start an associated timer of duration “Extension Channel Access Timeout” and wait in the 40 MHz analogue mode for the HTAP to reset its NAV by a CF-End frame. Furthermore, upon reception of the Beacon Bcn or ICB frame in the control channel ch_a, a 40 MHz capable HTSTA will start the timer included in the Duration/ID field of the ICB frame or the contention free period (CFP) Parameter Set element in the Beacon frame Bcn. If the HTSTA operates in the 20 MHz mode, it will shift to 40 MHz analogue mode by the reception of the Beacon Bcn or the ICB frame on the control channel ch_a. A HTSTA will switch to 40 MHz analogue mode within at least “aMax40MhzAnalogueSwitchingTime” time.

In case the “extension channel access timeout” timer expires before receiving the CTS-to-self or Beacon Bcn on the extension channel, a 40 MHz capable HTSTA leaves the waiting state. It will switch back to 20 MHz mode on the control channel ch_a depending on the operation mode of the HTAP.

When a 40 MHz capable HTSTA receives a CF-end frame, its NAV for the 40 MHz channel will be reset and it becomes free to access in 40 MHz mode. The 40 MHz capable HTSTA switches back to 20 MHz mode on the control channel ch_a if the timer runs out before it receives the DCB frame (decrease of bandwidth) which indicates the end of the 40 MHz period. By the reception of a DCB frame from the HTAP on the 40 MHz channel, a 40 MHz capable HTSTA sets its NAV for the 40 MHz channel. It may switch back to 20 MHz mode if it wishes to communicate in the 20 MHz period when receiving the DCB frame.

A 40 MHz capable HTSTA that is attempting an channel access during a 40 MHz period freezes the backoff counter during 20 MHz operation and resumes the interrupted backoff during the next 40 MHz period. Likewise, if it is attempting a channel access during a 20 MHz period, it freezes the backoff counter during 40 MHz operation and resumes the interrupted backoff during the next 20 MHz period.

For operation of legacy STAs and 20 MHz HT STAs the NAVs of Legacy STAs and 20 MHz HT STAs are set either by a Beacon Bcn or ICB frame in the control channel ch_a or by the CTS-to-self or Beacon frame Bcn in the extension channel ch_b. Their NAVs are reset when they receive a CF-End frame in their operating channel.

The embodiments of the present invention described herein are intended to be taken in an illustrative and not a limiting sense. Various modifications may be made to these embodiments by those skilled in the art without departing from the scope of the present invention as defined in the appended claims.

For instance, although the invention is discussed in relation with a wireless communication system that utilizes two channels, a control channel and an extension channel, it will be obvious for a skilled person that same method of creating time slots for low-speed mode communication and other time slots for high-speed communication can be used in a wireless communication system utilizing more than two channels.

1. A wireless communication system comprising a master station, a first additional station, and a second additional station, whereby the master station is operable to communicate with the first and second additional stations in a first high-speed mode utilizing a first channel and at least a second channel and in a second low-speed mode utilizing either the first channel or the second channel, the first additional station is operable to communicate in the first mode utilizing the first channel and at least the second channel, and the second additional station is arranged to communicate in the second mode utilizing either the first channel or the second channel, characterized in that master station is arranged to define a plurality of first time slots on the first channel and a plurality of second timeslots on the second channel for communication in the first mode, and a plurality of third time slots on the first channel and a plurality of fourth time slots on the second channel for communication in the second mode.

2. A communication system as claimed in claim 1, characterized in that the plurality of first time slots and the plurality of second time slots coincide with each other.

3. A communication system as claimed in claim 1, characterized in that the plurality of first time slots and the plurality of second time slots have an offset with respect to each other.

4. A communication system as claimed in claim 1, characterized in that the plurality of third time slots and the plurality of fourth time slots coincide with each other.

5. A communication system as claimed in claim 1, characterized in that the plurality of third time slots and the plurality of fourth time slots have an offset with respect to each other.

6. A wireless communication system as claimed in claim 1, characterized in that the communication in the second mode is compliant with IEEE Std. 802.11a, IEEE Std. 802.11b, or IEEE Std. 802.11g.

7. A wireless communication device for use as a master station in a wireless communication system, the wireless communication system further comprising a first additional station and a second station, whereby the wireless communication device is arranged to communicated with the additional station in a first high-speed mode utilizing a first channel and at least a second channel, whereby the wireless communication device is further arranged to detect if the second additional station transmits in a second low-speed communication mode in either the first channel or the second channel, characterized in that the communication device is further arranged to define a plurality of first time slots on the first channel and a plurality of second timeslots on the second channel for communication in the first mode, and a plurality of third time slots on the first channel and a plurality of fourth time slots on the second channel for communication in the second mode in response to the detection of low-speed mode transmission in either the first channel or the second channel.

8. A wireless communication device as claimed in claim 7, characterized in that the communication in the second mode is compliant with IEEE Std. 802.11a, IEEE Std. 802.11b, or IEEE Std. 802.11g.

9. A method of communicating in a wireless communication system comprising a master station, a first additional station, and a second additional station, whereby the master station communicates with the first and second additional stations in a first high-speed mode utilizing a first channel and at least a second channel and in a second low-speed mode utilizing either the first channel or the second channel, the first additional station communicates in the first mode utilizing the first channel and at least the second channel, and the second additional station communicates in the second mode utilizing either the first channel or the second channel, characterized in that master station defines a plurality of first time slots on the first channel and a plurality of second timeslots on the second channel for communication in the first mode, and a plurality of third time slots on the first channel and a plurality of fourth time slots on the second channel for communication in the second mode.
